(19) United States
(12) Patent Application Publication
(10) Pub. No.: US 2014/0164890 A1
(43) Pub. Date: Jun. 12, 2014

(54) INSERTION AND PLAYBACK OF VIDEO IN DOCUMENTS

(71) Applicant: MICROSOFT CORPORATION, Redmond, WA (US)

(72) Inventors: Seth Fox, Seattle, WA (US); Tristan Davis, Redmond, WA (US); Ali Taleghani, Seattle, WA (US)

(73) Assignee: MICROSOFT CORPORATION, Redmond, WA (US)

(21) Appl. No.: 13/709,063

(22) Filed: Dec. 10, 2012

(51) Int. Cl. G06F 17/24

(52) U.S. Cl. CPC G06F 17/24
USPC 715/202

(57) ABSTRACT

Technologies are described herein for generating a document. A video object corresponding to a web-based video may be retrieved. The video object may include a default image and an embed code. The playable graphical object may superimpose an indicator on the default image. The playable graphical object may also be associated with the embed code. The playable graphical object may be inserted into the document via a productivity application.

### BACKGROUND

A document can convey information to a user via multimedia content, which includes text, images, audio, video, or combinations thereof. While text, images, and audio can be sufficient in some contexts, video enables a level of rich communication that may not be matched. For example, a document intended to instruct a user on a do-it-yourself project might include a video showing an expert working through the steps of the project. Such video may provide information and/or context that cannot be expressed by text, images, and/or audio alone.

Conventional approaches for including video in documents have several drawbacks. In particular, conventional approaches do not provide an intuitive experience for inserting, manipulating, and playing video, including web-based video, in documents. Further, conventional approaches do not account for the dual-nature of a digital document as an online-viewable document and a printed document.

It is with respect to these considerations and others that the disclosure made herein is presented.

### SUMMARY

Technologies are described herein for the insertion and playback of video in documents. When inserting a video according to a document, a user may insert a playable graphical object corresponding to the video into the document. The playable graphical object may be associated with, among other things, video code relating to the video. Examples of video code may vary, but may include an embed code corresponding to the video, a link, such as a URL, corresponding to the video, or a representation of the video itself. The user may customize the playable graphical object in the document. Some customizations may include, but are not limited to, resizing, cropping, and/or applying visual effects to the playable graphical object as well as positioning the playable graphical object.

The user may view the document in a document viewing mode of a productivity application. When viewing the video, the user may select the playable graphical object in the document. In response to the user selection of the playable graphical object, the productivity application may transform from the document viewing mode to a video viewing mode. In the video viewing mode, the application may, among other things, display a video viewing window, open an external browser video viewing window, or display the video in-place in the document. The embed code associated with the playable graphical object, a link to the video, or the video itself, may be loaded in the video viewing window. The embed code may cause the video viewing window to display a viewing interface. Through the viewing interface, the user may control playback of the video.

In some example technologies, a method for generating a document is provided. According to the method, a video object corresponding to a web-based video may be retrieved. The video object may include a default image and an embed code. The playable graphical object may superimpose an indicator on the default image. The playable graphical object may also be associated with the embed code. The playable graphical object may be inserted into the document via a productivity application.

It should be appreciated that the above-described subject matter may also be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram illustrating a computing system configured to enable the insertion and playback of video in a document, in accordance with some embodiments presented herein;

FIGS. 2A-2F are screen display diagrams illustrating an example process for inserting a video into a document and testing playback of the video through the productivity application 104, in accordance with some embodiments presented herein;

FIGS. 3A-3B are screen display diagrams illustrating an example process for printing a document, in accordance with some embodiments presented herein;

FIG. 4 is a flow diagram illustrating an example method for inserting a video into a document, in accordance with some embodiments presented herein;

FIG. 5 is a flow diagram illustrating an example method for playing a video in a document, in accordance with some embodiments presented herein;

FIG. 6 is a flow diagram illustrating an example method for printing or converting a document, in accordance with some embodiments presented herein; and

FIG. 7 is a computer architecture diagram showing an illustrative computer hardware architecture for a computing system capable of implementing the embodiments presented herein.

### DETAILED DESCRIPTION

The following detailed description is generally directed to concepts and technologies for the insertion and playback of video in documents. Through the use of the concepts and technologies described herein, a productivity application, such as a word processing application, can be configured to enable the insertion of a video as a static graphical object. The productivity application may already provide functions (e.g., multiple layout options, live text reflow, alignment guides, etc.) for manipulating static graphical objects. Thus, by representing the video as a static graphical object, the productivity application can effectively leverage, for video, such existing functions that were designed for static graphical objects. For example, the static graphical object may be a thumbnail-sized still frame from the video.

The productivity application may provide various functions for customizing the static graphical object and inserting the static graphical object into the document. Example functions may enable the creating user to choose the still frame from the video or from another source, whether or not in the video, to resize the still frame, to crop the still frame, and to apply visual effects to the still frame. Example functions may also enable the creating user to place, orient, and arrange the static graphical object upon insertion in a document. Example functions may further support multiple layout options, live text reflow, alignment guides, and the like.

The static graphical object may be either a playable graphical object or a non-playable graphical object. For example, the playable graphical object may contain a play button superimposed on the still frame. The non-playable graphical object may not contain the play button. When the creating user initially inserts the video as the static graphical object in the document, the static graphical object may be a playable graphical object.

A viewing user may utilize the productivity application to view the document. Upon opening the document, the productivity application may initially display the document in a document viewing mode. In the document viewing mode, productivity application may display a document interface configured to display the document. While the productivity application is in the document viewing mode, the viewing user may select the playable graphical object in order to view the video corresponding to the playable graphical object.

When the viewing user selects the playable graphical object, the productivity application may transform from the document viewing mode to a video viewing mode, open a new browser window, or play the video in the document viewing mode. It should be appreciated that the present disclosure is not limited to any one particular technology for a video viewing mode. Various embodiments and examples provided herein are illustrative only and do not reflect an intent to limit a video viewing mode to any one technology. In the video viewing mode, the productivity application may launch a video viewing window on top of the document interface. The video viewing window may be positioned at or near the center of the viewing user's screen and may be configured to display the video at an appropriate size. The size, position, and arrangement of the video viewing window may be independent of the size, position, and arrangement of the playable graphical object in the document. When the viewing user has finished viewing the video, the productivity application may transform from the video viewing mode back to the document viewing mode in which the video viewing window has been removed.

In some instances, the viewing user may request to print the document or to convert the document into another format that does not support the video viewing mode. In such instances, the productivity application may replace the playable graphical object with the non-playable graphical object prior to printing or converting the document. In some instances, one or more features, such as a “Play button” may be presented or hidden in views based on the applicability of the functionality of the features. In this manner, the printed document and document that does not support the video viewing mode may not show the play button contained in the playable graphical object. In some configurations below, the format that does not support the video viewing mode is described in terms of a portable document format (or PDF), though it should be understood that other formats may not support the video, and are considered to be within the scope of the present disclosure. Further, it should be appreciated that some implementations of the PDF format may support the video viewing mode, and that the present disclosure uses the PDF format for descriptive purposes only.

The viewing user may utilize a separate document viewer (e.g., a PDF viewer) to view the converted document. While viewing the converted document in the document viewer, the viewing user may select the non-playable graphical object. The non-playable graphical object may contain a hyperlink to a web page configured to play the video. Thus, when the viewing user selects the non-playable graphical object, the document viewer may cause the viewing user's computer to launch a web browser that loads the web page.

For purposes of clarity and illustration, some embodiments and examples described herein refer separately to a “creating user” and/or a “viewing user.” The creating user generally refers to a user who creates a document. The viewing user generally refers to a user who views the document. It should be appreciated that, in some instances, the creating user and the viewing user may be the same user with respect to a particular document. For example, a given user may create a document. After creating the document, the user may view a video contained in the document in order to test the document and confirm that the document was properly created.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

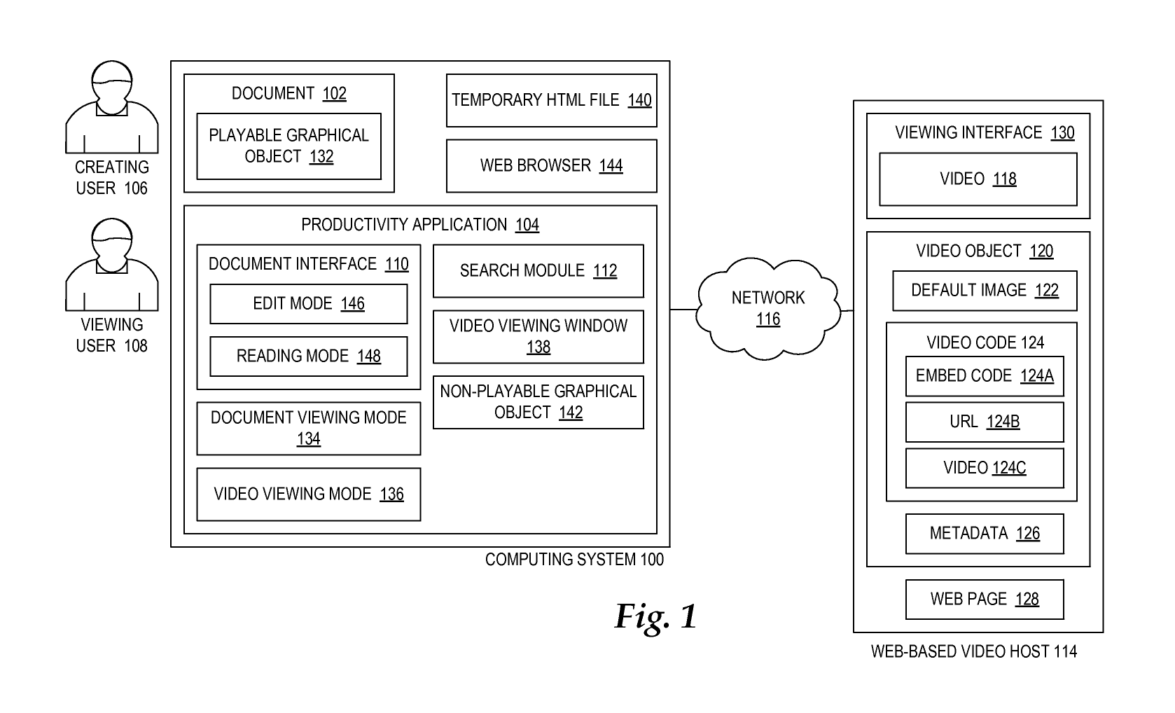

In the following detailed description, references are made to the accompanying drawings that form a part hereof, and which are shown by way of illustration, specific embodiments, or examples. Referring now to the drawings, in which like numerals represent the insertion and playback of video in a document will be described. In particular, FIG. 1 is a block diagram illustrating a computing system 100 configured to enable the insertion and playback of video in a document 102, in accordance with some embodiments presented herein.

The computing system 100 may include a productivity application 104. The productivity application 104 may be utilized by a creating user 106 during a document creation process. The document creation process may refer to the creation of the document 102. During the document creation process, the productivity application 104 may provide functions enabling the creating user 106 to insert video into the document 102. In addition, the productivity application 104 may be utilized by a viewing user 108 during a document viewing process. The document viewing process may refer to the interaction by the viewing user 108 with the document 102 after it has been created. During the document viewing process, the productivity application 104 may provide functions enabling the playback of video in the document 102.

In an illustrative document creation process, the creating user 106 may be tasked with creating the document 102 using the productivity application 104. In some embodiments, the productivity application 104 may be a word processing application. In other embodiments, the productivity application 104 may be any suitable application capable of creating documents containing at least text and video. The productivity application 104 may provide a document interface 110 enabling the creating user 106 to view and/or edit the document 102.

While creating the document 102, the creating user 106 may desire to insert video into the document 102. In an illustrative example, the creating user 106 may desire to insert web-based video into the document 102. Some examples of web-based video hosts include YOUTUBE and VIMEO. Because web-based video is hosted remotely and is streamed upon request, the inclusion of web-based video into the document 102 does not significantly impact the file size of the document 102 and precludes the need for transferring potentially large video files. Thus, embodiments described herein for the insertion playback of video in the document 102 refer primarily to web-based video. However, it should be appreciated that such embodiments may be similarly implemented for local video files. It should also be appreciated that the video file may reside in one or more locations based on the use and connectivity of the particular machine upon which the video is to be played. For example, the video file may be embedded within the document 102 for local storage or may be uploaded to a private cloud server in order to make the video accessible to other machines. In other instances, it may be beneficial to store cached copies of online videos to allow for offline playback.

In order to insert web-based video into the document 102, the creating user 106 may access a search module 112. The search module 112 may provide the creating user 106 with a search interface coupled to a remote search service (not shown). The remote search service may be configured to search for web-based videos from one or more web-based video hosts, such as a web-based video host 114. The remote search service may be accessed via a communications network 116. Through the search interface, the creating user 106 may submit one or more keywords. For purposes of clarity and illustration, the keywords may include, but are not limited to, text strings, a uniform resource locator (“URL”), embed code, etc., the present disclosure of which is not limited to any particular type of keyword.

The remote search service may retrieve search results of web-based videos that match the submitted keywords and return the search results to the search module 112. The search module 112 may present the search results to the creating user 106, and the creating user 106 may select one of the web-based videos, such as a video 118, for insertion into the document 102.

In some other examples, video 118 can be inserted using various programming languages like VBA or through the use of add-ins or apps. One or more of the various methods provided herein may provide alternate interfaces, experiences or workflows for video insertion. It should be appreciated that the use of search module 112 is merely for purposes of illustration, as other methods of inserting web-based video may be used in accordance with the various concepts and methods disclosed herein, including entering a URL or embed code of the web-based video without the need to perform a search for the web-based video.

Each of the web-based videos returned in the search results may be associated with a video object. For example, the video 118 selected by the creating user 106 may be associated with a video object 120. In some examples, video object 120 may have video code 124 relating to the video 118 that the user 106 may use for inserting the video 118 into various formats. In some examples, the video code 124 may be, but is not limited to, an embed code 124A associated with the video 118, a URL 124B providing a link to the video 118, or video 124C representing either the video 118 itself or a snippet of the video 118. For purposes of clarity and illustration, some examples below are described as using embed code 124A, though it should be appreciated that other types of video code 124, including types not explicitly disclosed herein, may be used and are considered to be within the scope of the present disclosure.

The video object 120 may also include a default image 122 and metadata 126. The default image 122 may be a thumbnail-sized still frame from the video 118. In some embodiments, the default image 122 may be a random still frame from the video 118 or predefined (e.g., by the uploader). In other embodiments, the default image 122 may be selected based on some suitable criteria and/or analysis of the video 118. If no default image is provided by the remote search service, the productivity application 104 may utilize a fixed-size generic image or some other image placeholder. The embed code 124A may refer to a block of data containing source code and other information utilized or needed to access the video 118, via the communications network 116, and to play the video 118 inline within a window provided by the productivity application 104. This information can include the path to the video 118, the height and width of the video 118, and/or the like. The metadata 126 may include, for example, a URL to a web page 128 configured to play the video 118 and/or the height and width of the video 118. The metadata 126 may also include other information regarding the video 118, such as a name of the video 118, a name of the uploader, a description of the video 118, the number of times the video 118 has been watched, and/or a length of the video 118.

In some embodiments, the path to the video 118 may provide access to a viewing interface 130 configured by the web-based video host 114. Additionally, in some embodiments, a user may be able to preview video 118 prior to inserting video 118 into document 102. As described in greater detail below, the productivity application 104 may provide a window that loads the viewing interface 130. The productivity application may load the embed code 124A in the window, thereby causing the window to display the viewing interface 130. Through the viewing interface 130, a user may play the video 118 inline within the window. Through the viewing interface 130, a user may also control playback of the video 118 through various video viewing options provided by the web-based video host 114. Some example video viewing options may include a play function, a pause function, volume control, a link to a source page to play video 118, autoplay feature, a feature to render the video 118 in full screen, and closed captioning.

When the creating user 106 selects the video 118 for insertion into the document 102, the remote search service may provide at least a portion of the video object 120 to the productivity application 104. The productivity application 104 may generate a playable graphical object 132 based on the default image 122. In particular, the productivity application 104 may superimpose a play button or other suitable indicator on the default image 122. The playable graphical object 132 may contain transformation logic that causes the productivity application 104 to transform from a document viewing mode to a video viewing mode. For example, the transformation logic may be triggered when a user, such as the viewing user 108, selects the play button or some other portion of the playable graphical object 132. Additional details regarding the document viewing mode and the video viewing mode will be provided below.

Upon generating the playable graphical object 132 the productivity application 104 may insert the playable graphical object 132 into the document 102. For example, the productivity application 104 may insert the playable graphical object 132 at a random location or at the current location of a cursor. The creating user 106 may then move the playable graphical object 132 (e.g., via a drag interface and/or copy/paste) to a different location in the document 102. In some configurations, the creating user 106 may also move the playable graphical object 132 (e.g. via a drag interface and/or copy/paste) to other documents or other applications. The productivity application 104 may also associate the embed code 124A with the playable graphical object 132.

In some embodiments, the productivity application 104 may provide live text reflow as the playable graphical object 132 is moved. Live text reflow may cause text located at or near where the playable graphical object 132 has been placed to wrap around the playable graphical object 132. The productivity application 104 may provide various settings with which the creating user 106 can customize the live text reflow. In some embodiments, the productivity application 104 may provide multiple layout options or alignment guides to assist the creating user 106 in the placement, arrangement, and orientation of the playable graphical object 132 for insertion into the document 102.

In some embodiments, the productivity application 104 may provide functions enabling the creating user 106 to change the image of the playable graphical object 132. For example, if the default image 122 is a particular still frame in the video 118, then the playable graphical object 132 may contain that still frame. In some embodiments, the productivity application 104 may provide functions enabling the creating user 106 to select another still frame in the video 118 for use in the playable graphical object 132. In other embodiments, the productivity application 104 may provide functions enabling the creating user 106 to select an image from local and/or remote content stores for use in the playable graphical object 132.

In some embodiments, the productivity application 104 may provide functions enabling the creating user 106 to resize the playable graphical object 132, to crop the playable graphical object 132, rotate the playable graphical object 132, and/or to apply visual effects to the playable graphical object 132. Some example visual effects may include shadow, reflection, and glow. It should be appreciated that other customizations designed for static graphical objects (e.g., images, shapes, etc.) may be applied to the playable graphical object 132 as contemplated by one skilled in the art.

The creating user 106 may insert one or more playable graphical objects, such as the playable graphical object 132, into the document 102. Each playable graphical object may correspond to a particular web-based video. For example, the playable graphical object 132 may correspond to the video 118.

When the creating user 106 has created the document 102, the document 102 may be distributed or otherwise provided to other users, such as the viewing user 108. The viewing user 108 may open the document 102 using the productivity application 104. In particular, the productivity application 104 may provide the document interface 110. The document interface 110 may enable the viewing user 108 to view and/or edit the document 102.

The productivity application 104 may initially display the document 102 in a document viewing mode 134. The document viewing mode 134 may refer to a default mode of the productivity application 104 when the document 102 is opened. In the document viewing mode 134, the viewing user 108 may be permitted to perform a variety of standard functions, such as viewing, editing, and/or scrolling, with respect to the document 102. The document viewing mode 134 may be the same mode in which the creating user 106 created the document 102.

While viewing the document 102 in the document viewing mode 134 of the productivity application 104, the viewing user 108 may desire to view the video 118 associated with the playable graphical object 132. In order to view the video 118, the viewing user 108 may select the playable graphical object 132. For example, the viewing user 108 may select the playable graphical object 132 using some sequence of one or more mouse clicks or one or more taps via a touchscreen interface. When the viewing user 108 selects the playable graphical object 132, the transformation logic in the playable graphical object 132 may cause the productivity application 104 to transform from the document viewing mode 134 to the video viewing mode 136.

In the video viewing mode 136, a video viewing window 138 may be placed on top of the document interface 110 displaying the document 102. In some embodiments, the video viewing window 138 may be dimmed, semi-transparent window. While the productivity application 104 is in the video viewing mode 136, the viewing user 108 may be restricted from performing at least some of the standard functions, such as viewing, editing, and/or scrolling, with respect to the document 102. In some implementations, the document interface 110 may be faded out in order to indicate that the standard functions are restricted.

The video viewing window 138 may be configured (e.g., sized, positioned, arranged, etc.) according to the embed code 124A associated with the playable graphical object 132. Through the embed code 124A, as previously described, the video viewing window 138 may display the viewing interface 130 to the viewing user 108. The viewing interface 130 may enable the viewing user 108 to play the video 118 inline within the video viewing window 138. The viewing interface 130 may also enable the viewing user 108 to control playback of the video 118 through various video viewing options, such as a play function, a pause function, volume control, and closed captioning. In some embodiments, video viewing window 138 may be positioned within document 102 according to various predetermined criteria, with a corresponding positioning of video 118 based on the positioning of video viewing window 138.

When the viewing user 108 is finished viewing the video 118, the viewing user 108 may cause the productivity application 104 to transform from the video viewing mode 136 back to the document viewing mode 134. For example, the viewing user 108 may select (or click or tap, by way of example) any portion of the document interface 110 outside of the video viewing window 138 using a mouse or touchscreen interface. The transformation from the video viewing mode 136 back to the document viewing mode 134 may remove the video viewing window 138. When the video viewing window 138 has been removed, the viewing user 108 may again have access to the standard functions, such as viewing, editing, and/or scrolling, with respect to the document 102. In some embodiments, a user may also use a keyboard to perform one or more functions discussed above.

During the transformation from the document viewing mode 134 to the video viewing mode 136, the productivity application 104 may be configured to generate a temporary HyperText Markup Language (“HTML”) file 140 that configures the video viewing window 138. The temporary HTML file 140 made contain logic configured to handle various events encountered when playing the video 118. Some examples of such logic will be provided below. The productivity application 104 may insert the embed code 124A into the temporary HTML file 140. The temporary HTML file 140 may be loaded in the video viewing window 138. The temporary HTML file 140 may be erased after the video viewing window 138 has been removed (e.g., after the transformation from the video viewing mode 136 back to the document viewing mode 134).

Some examples of the logic will now be described. A first example logic may be configured to handle to a missing plugin. If the computing system 100 does not have a plugin (e.g., MICROSOFT SILVERLIGHT, FLASH, etc.) needed to play the video 118, the first logic may notify the viewing user 108 and/or provide instructions to the viewing user 108 for obtaining the plugin. A second example logic may be configured to handle window resize. The second example logic may be configured the size the video viewing window 138 in accordance with particular dimensions. Such dimensions may be provided by the embed code 124A (e.g., the height and width of the video 118) or extracted from the video 118 itself. If the dimensions cannot be extracted from the video 118, then a fixed percentage of the screen size may be used. A third example logic may be configured to handle dynamic centering. The third example logic may be configured to center the video viewing window 138 on the screen of the viewing user 108. A fourth example logic may be configured to handle possible issues with client-side scripting. If client-side scripting has been disabled or is not supported by the computing system 100, the fourth example logic may notify the viewing user 108. Other logic to include in the temporary HTML file 140 may be contemplated by one skilled in the art. A fifth example logic may be configured to size and position the video viewing window 138. The productivity application 104 may have software that handles the size and position of video viewing window 138 while HTML, or another analogous language, may handle the size and position of video 118 within video viewing window 138. In some embodiments, the HTML, CSS and JavaScript of the base HTML page can be used to make additional visuals to enhance the display or enhance the video.

In some instances, the productivity application 104 may be unable to generate the playable graphical object 132. For example, the remote search service may be unable to provide the embed code 124A or the save format of the productivity application 104 may not be one supports storage of the information needed to generate the playable form of the video 118. In such instances, the productivity application 104 may generate a non-playable graphical object 142 based on the default image 122. Unlike the playable graphical object 132, the non-playable graphical object 142 may not include the play button superimposed on the default image 122. Further, unlike the playable graphical object 132, the non-playable graphical object 142 may not include the transformation logic that causes the productivity application 104 to transform from the document viewing mode 134 to the video viewing mode 136. In some embodiments, productivity application 104 may alert a user prior to the insertion of video 118 if it is detected that video 118 will not play as expected. This may help the user correct the reason for the error.

The non-playable graphical object 142 may be associated with a hyperlink to the URL contained in the metadata 126. As previously described, the URL may correspond to the web page 128 configured to play the video 118. The web page 128 may be hosted by the web-based video host 114 of the video 118. The viewing user 108 may access the web page 128 by selecting the non-playable graphical object 132. For example, the selection of the non-playable graphical object 142 by the viewing user 108 may cause a web browser 144 or other suitable external application to load the web page 128 via the URL. If the URL is not included in the metadata 126, then the non-playable graphical object 142 may not be associated with the hyperlink. In some embodiments, a user may be able to add metadata 126 at various times in the process. In another embodiment, the viewing user 108 may be able to change video 118 and replace video 118 with another video, as well as, change the metadata 126 associated with each.

In some instances, the viewing user 108 may prefer to view the video 118 in the web browser 144 instead of viewing the video 118 inline within the video viewing window 138. In such instances, the playable graphical object 132 may be configured with a context menu from which the viewing user 108 can launch the web browser 144 to load the web page 128. For example, the context menu may be accessed via right mouse click or some other suitable command. In other examples, the viewing user 108 may be able to play video 118 in the web browser 144 using various other types of mechanisms, the present disclosure of which is not limited to any one or more particular technologies.

In some embodiments, the creating user 106 may request to print the document 102. In particular, the document interface 110 may include functions enabling the creating user 106 to print the document 102. When the document 102 is printed on paper, the play button in the playable graphical object is no longer needed. In this regard, the productivity application 104 may replace the playable graphical object 132 with the non-playable graphical object 142 prior to printing the document 102. In this manner, the play button is not displayed in the printed document. In other embodiments, the play button may also be removed from display when a print preview is being performed.

In some embodiments, the creating user 106 may desire to convert the document 102 from a first file format that supports the video viewing mode 136 to a second file format that does not support the video viewing mode 136. For example, the creating user 106 may desire to convert the document 102 to a PDF file format. Because the PDF file format does not support the video viewing mode 136, the playable graphical object 132 may no longer be applicable for purposes of the conversion. In this case, the productivity application 104 may replace the playable graphical object 132 with the non-playable graphical object 142 prior to the conversion. Because the PDF file format does support hyperlinks within PDF documents, the non-playable graphical object 142 may be associated with a hyperlink to the URL contained in the metadata 126.

In some embodiments, the productivity application 104 may be configured to display the document 102 in either an edit mode 146 or a reading mode 148 of the document interface 110. The edit mode 146 may refer to a mode of the productivity application 104 in which toolbars, ribbons, and/or other interface elements are displayed in addition to the document 102. The reading mode 148 may refer to a mode of the productivity application 104 in which at least some of these interface elements are not displayed in addition to the document 102. By removing such interface elements, a greater area of a given screen space can be occupied by the document 102. This may allow for a greater amount of content to be displayed or the use of a larger font size to display the same amount of content.

The productivity application 104 may be configured to behave differently depending on whether the productivity application 104 is displayed the document 102 in the edit mode 146 or the reading mode 148. For example, if the productivity application 104 displays the document 102 in the edit mode 146, a single mouse click (or single tap via a touchscreen interface) may cause the productivity application 104 to transform from the document viewing mode 134 to the video viewing mode 136. In contrast, if the productivity application 104 displays the document 102 in the reading mode 148, a double mouse click (or double tap via a touchscreen interface) may cause the productivity application 104 to transform from the document viewing mode 134 to the video viewing mode 136.

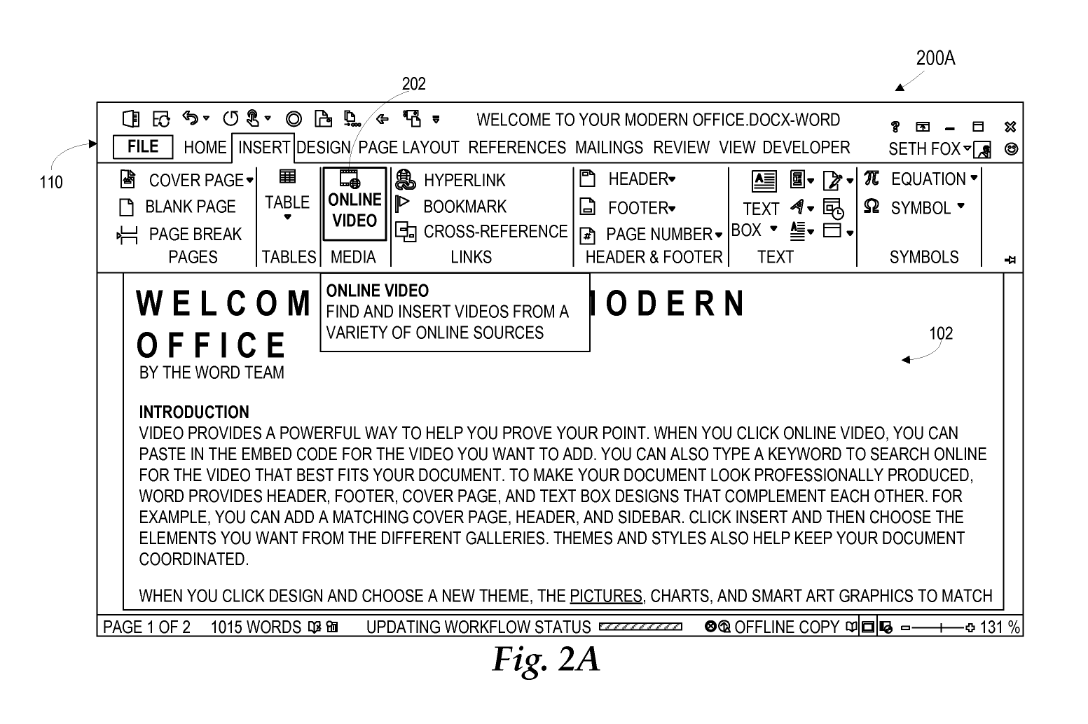

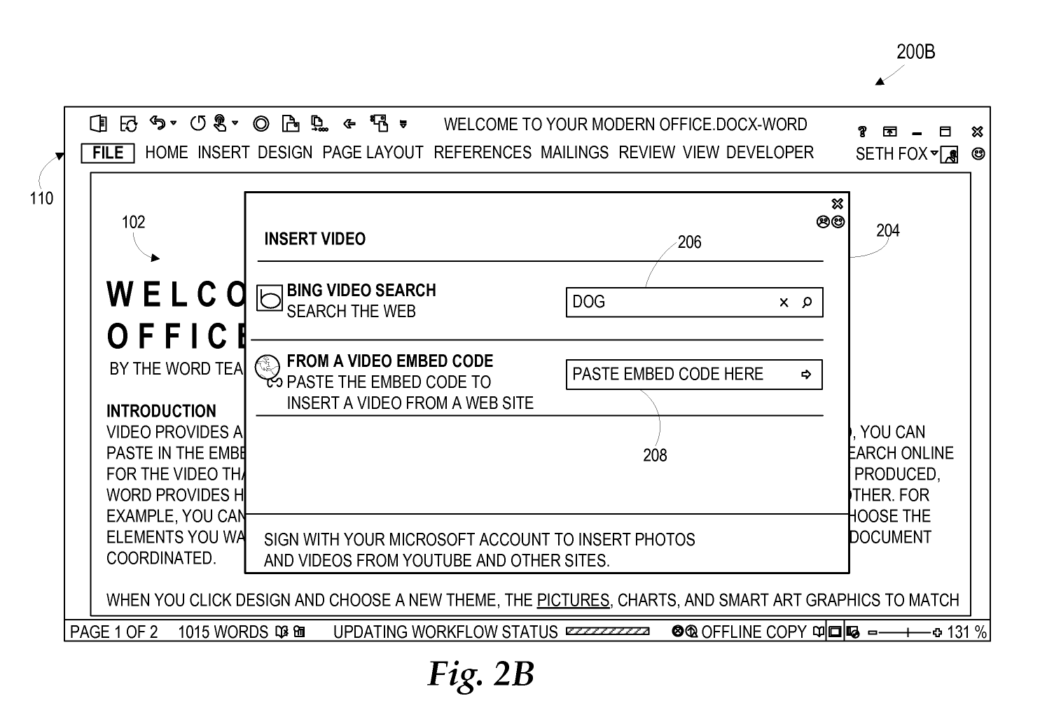

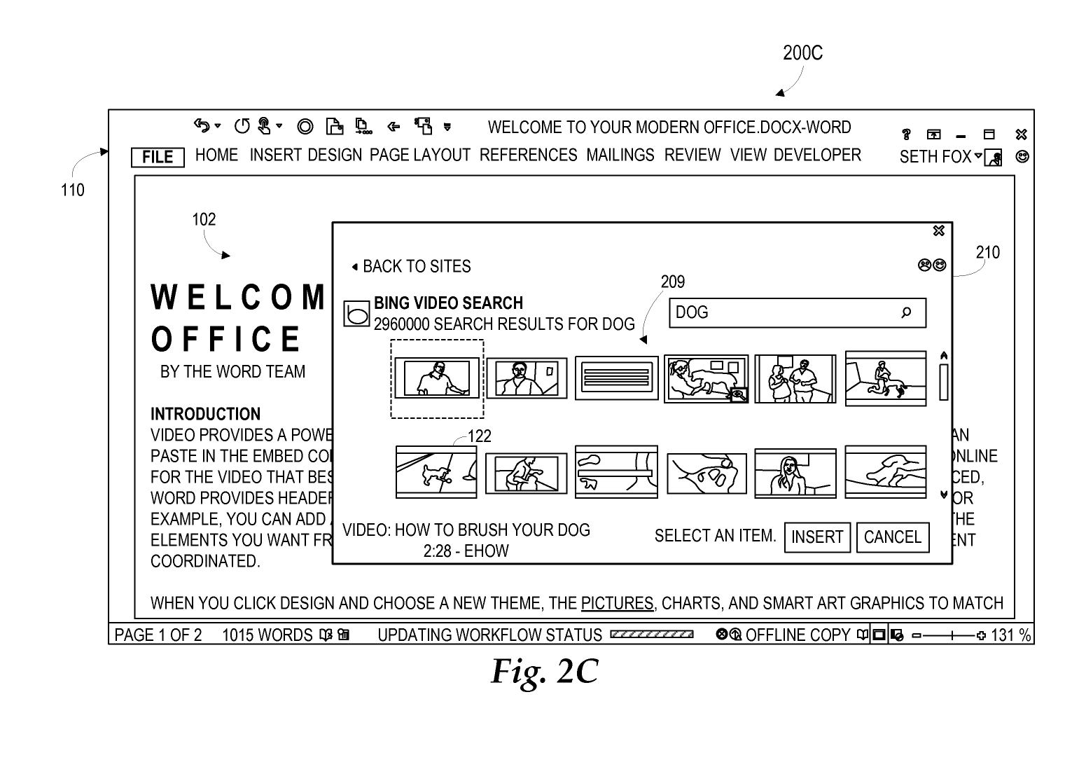

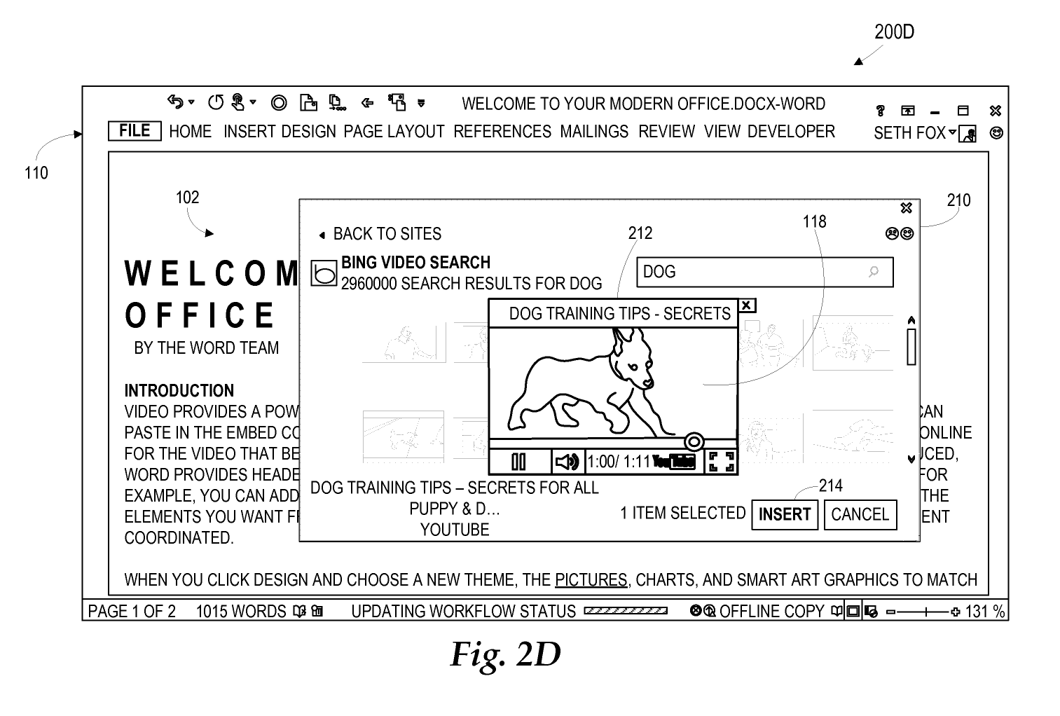

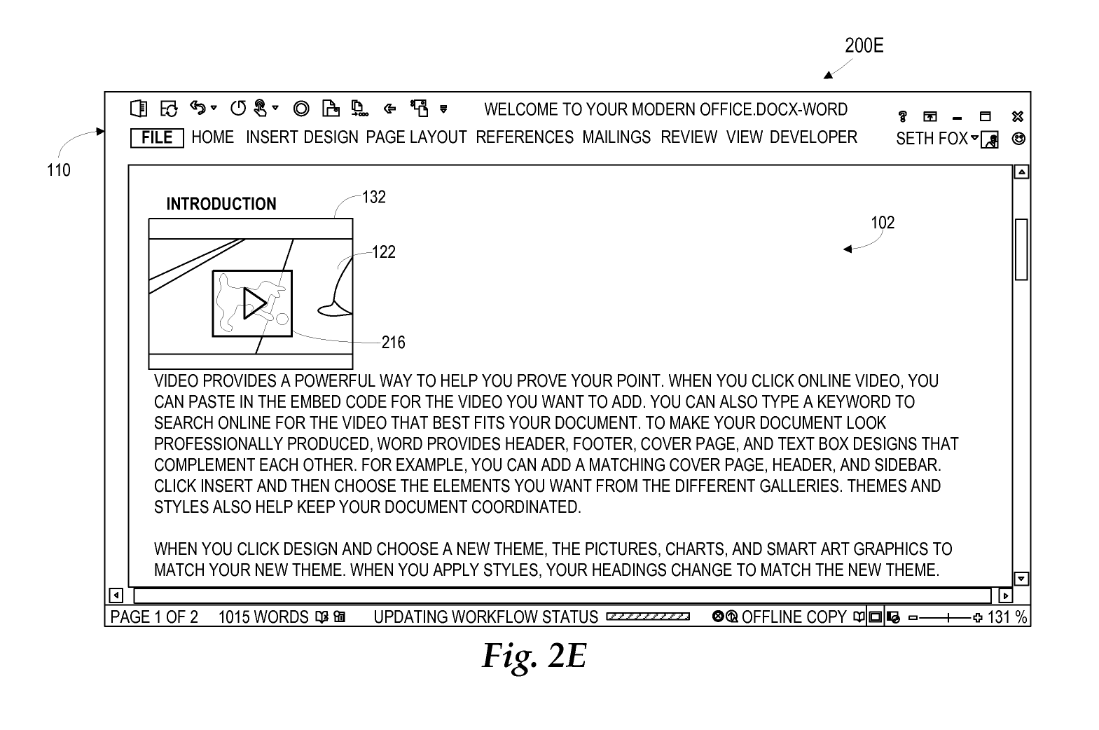

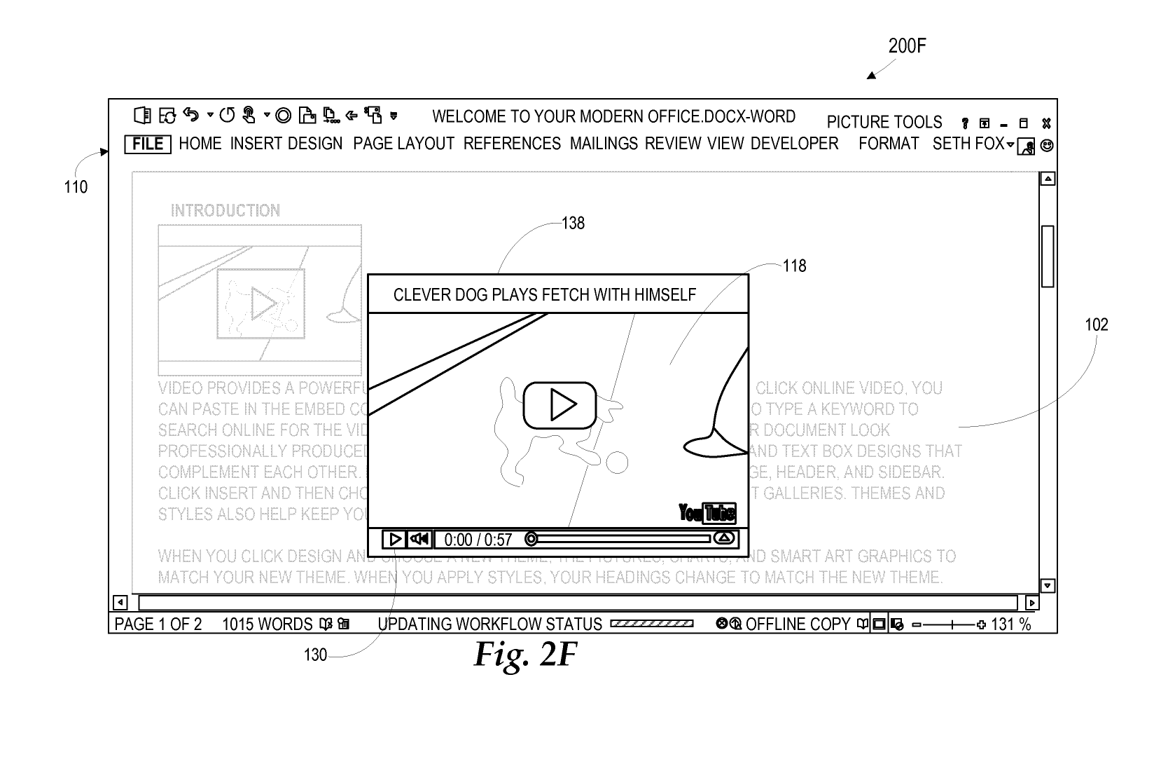

Referring now to FIGS. 2A-2F, additional details regarding the operation of the productivity application 104 will be described. In particular, FIGS. 2A-2F are screen display diagrams illustrating an example process for inserting a video into the document 102 and testing playback of the video through the productivity application 104, in accordance with some embodiments presented herein. FIG. 2A is a screen display diagram 200A showing an example implementation of the document interface 110. The document interface 110 may be configured to display the document 102. The document interface 110 may include an interface element 202 enabling the creating user 106 to initiate an online search in order to find a video for insertion into the document 102. In the example illustrated in FIG. 2A, the creating user 106 selects the interface element 202 to initiate the online search.

FIG. 2B is a screen display diagram 200B illustrating an example implementation of the document interface 110 after the interface element 202 has been selected to initiate the online search. When the creating user 106 initiates the online search, the document interface 110 may display an insertion interface 204. The insertion interface 204 may include a search interface 206 enabling the creating user 106 to submit one or more keywords to search for web-based videos. The search interface 206 may also include a paste interface 208 enabling the creating user 106 to directly paste an embed code to insert a particular video into the document 102 without performing a search. In the example illustrated in FIG. 2B, the creating user 106 enters and submits the keyword “dog” into the search interface 206. In other embodiments, the creating user 106 may be able to insert a URL for the particular video or a URL for a page containing the particular video into document 102.

FIG. 2C is a screen display diagram 200C illustrating an example implementation of the document interface 110 after the keyword “dog” has been submitted. Through the search interface 206, the creating user 106 may submit the keyword “dog” to the remote search service. The remote search service may retrieve search results 209 of web-based videos corresponding to the keyword “dog.” The remote search service may return the search results 209 to the productivity application 104. The productivity application 104 may display a search results interface 210 containing the search results 209. Each of the search results 209 may be displayed by its corresponding default image, such as the default image 122 corresponding to the video 118 (not shown in FIG. 2C). In some embodiments, metadata about video 118 (e.g. title, provider, and length) may also be displayed. In the example illustrated in FIG. 2C, the creating user 106 selects the default image 122.

FIG. 2D is a screen display diagram 200D illustrating an example implementation of the document interface 110 after the default image 122 has been selected. When the creating user 106 selects the default image 122, the search results interface 210 may launch a preview window 212 with which the creating user 106 can view the video 118 corresponding to the default image 122. The search interface 206 may also include an interface element 214 enabling the creating user 106 to insert the default image 122 corresponding to the video 118 into the document 102. In the example illustrated in FIG. 2D, the creating user 106 selects the interface element 214 in order to insert the default image 122 (and effectively the video 118) into the document 102. In some embodiments, the creating user 106 may also insert the default image 122 into document 102 by double-clicking video 118. In other embodiments, the creating user 106 may be more than one user, wherein multiple creating users 106 may be able to insert one or more videos 118 into document 102 simultaneously or in some determined order, thereby allowing more than one person to collaborate, create and/or amend document 102.

FIG. 2E is a screen display diagram 200E illustrating an example implementation of the document interface 110 after the default image 122 has been selected for insertion into the document 102. When the creating user 106 selects the default image 122, the productivity application 104 may generate the playable graphical object 132 based on the default image 122. For example, the productivity application 104 may superimpose a play button 216 on the default image 122 to form the playable graphical object 132. The playable graphical object 132 may also include transformation logic that causes the productivity application 104 to transform from the document viewing mode 134 to the video viewing mode 136. In the example illustrated in FIG. 2E, the transformation logic may be triggered when the creating user 106 selects the play button 216.

Upon generating the playable graphical object 132, the productivity application 104 may insert the playable graphical object 132 into the document 102. The document interface 110 may provide a drag interface enabling the creating user 106 to move the playable graphical object 132. The document interface 110 may also provide functions enabling the creating user 106 to customize (e.g., resize, crop, apply visual effects to, etc.) the playable graphical object 132. In the example illustrated in FIG. 2E, the creating user 106 selects the play button 216, thereby triggering the transformation logic.

FIG. 2F is a screen display diagram 200F illustrating an example implementation of the document interface 110 after the play button 216 has been selected. The selection of the play button 216 by the creating user 106 may trigger the transformation logic causing the productivity application 104 to transform from the document viewing mode 134 to the video viewing mode 136. In the video viewing mode 136, the productivity application 104 may display the video viewing window 138 on top of the document interface 110. The document interface 110 may also be faded out to indicate that at least some of the standard functions, such as viewing, editing, and/or scrolling, with respect to the document 102 have been disabled. The video viewing window 138 may display the viewing interface 130. The viewing interface 130 may enable the creating user 106 to play the video 118 inline within the video viewing window 138 and to control playback of the video 118.

When the creating user 106 has finished viewing the video 118, the creating user 106 may select any visible part of the document interface 110 outside of the video viewing window 138. In response to the creating user 106 selecting a visible part of the document interface 110 outside of the video viewing window 138, the productivity application 104 may transform from the video viewing mode 136 back to the document viewing mode 134.

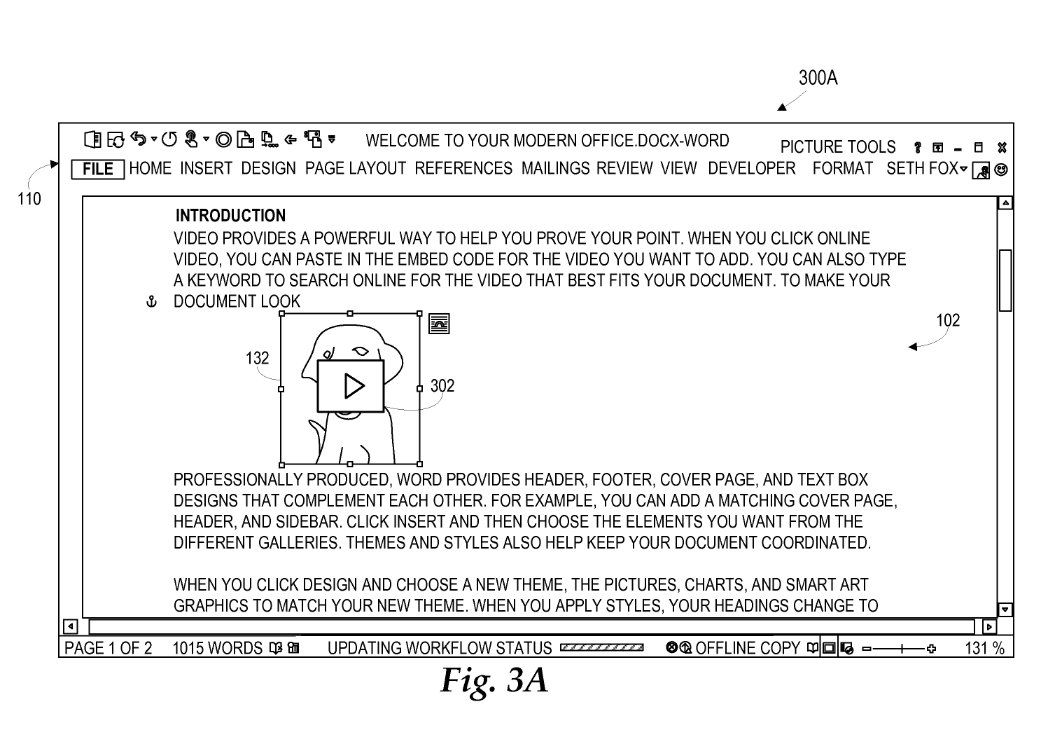

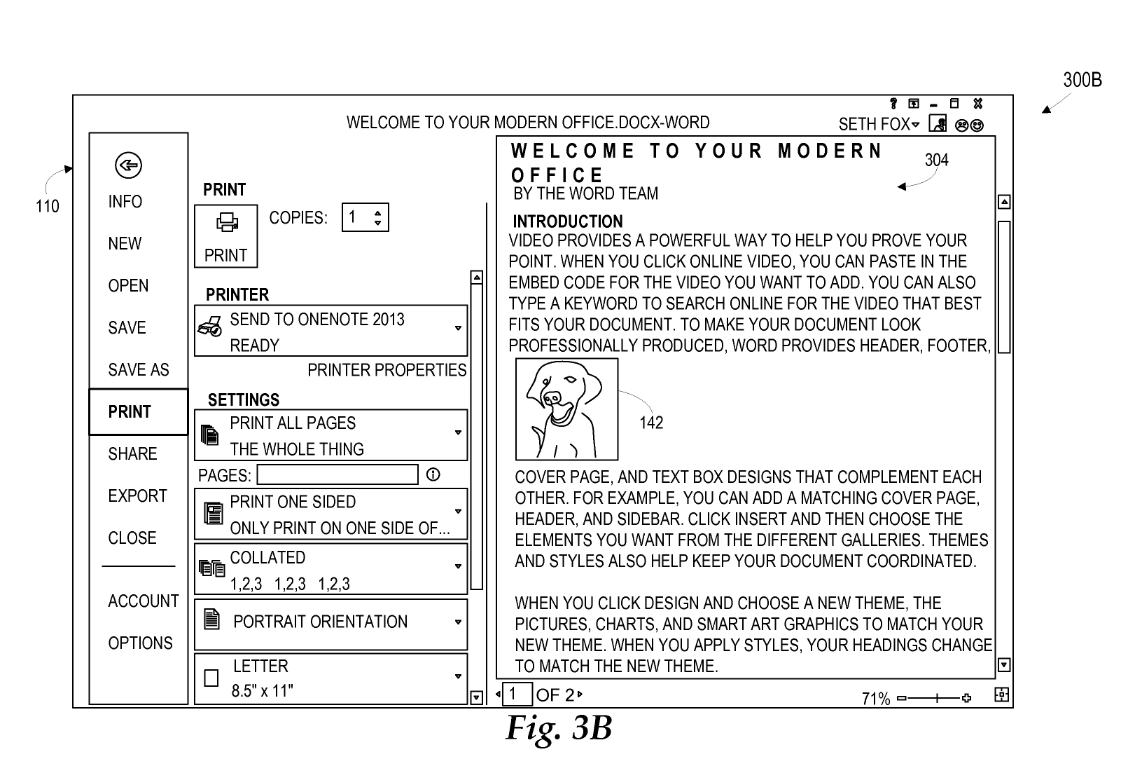

Referring now to FIGS. 3A-3B, additional details regarding the operation of the productivity application 104 will be described. In particular, FIGS. 3A-3B are screen display diagrams illustrating an example process for printing the document 102, in accordance with some embodiments presented herein. FIG. 3A is a screen display diagram 300A illustrating an example implementation of the document interface 110. The document interface 110 may be configured to display the document 102. The playable graphical object 132 has been inserted into the document 102. The playable graphical object 132 may be identified by a play button 302. In the example illustrated in FIG. 3A, the creating user 106 may initiate a print command through the document interface 110 in order to print the document 102.

FIG. 3B is a screen display diagram 300B illustrating an example implementation of the document interface 110 after the creating user 106 has initiated the print command. When the creating user 106 initiates the print command through the document interface 110, the document interface 110 may display, among other information, a print preview window 304. The print preview window 304 may display a preview of the printed document. As illustrated in the print preview window 304, in response to the creating user 106 initiating the print command, the productivity application 104 may replace the playable graphical object 132 with the non-playable graphical object 142. The non-playable graphical object 142 may be identified by the lack of the play button 302. By replacing the playable graphical object 132 with the non-playable graphical object 142 prior to printing the document, the printed document may not include the play button 302. In some embodiments, after printing the document 102 or exiting print preview window 304, the document 102 may still have video 118 with one or more play buttons displayed.

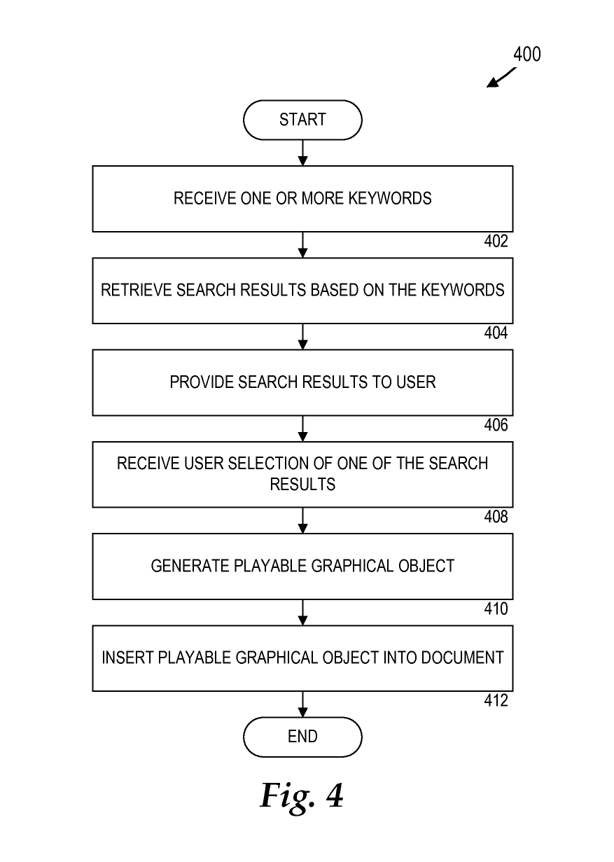

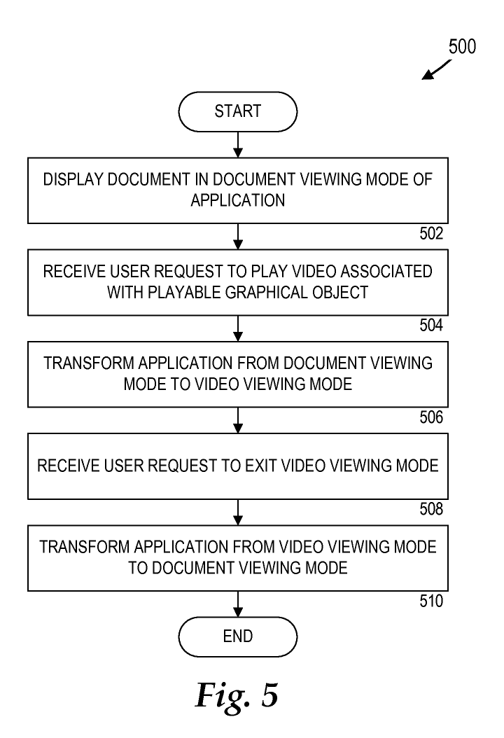

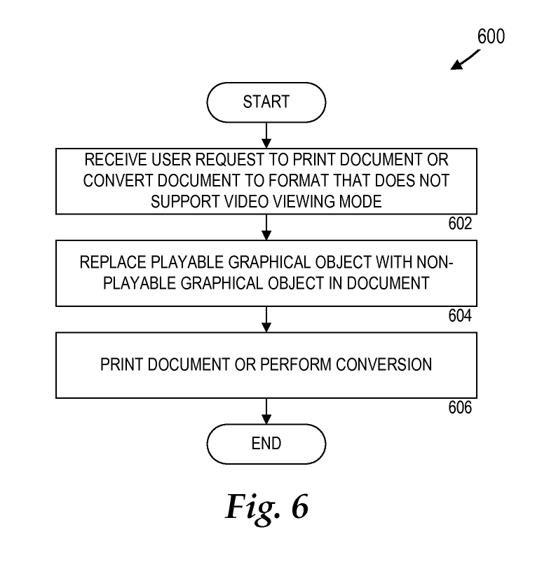

Referring now to FIGS. 4, 5, and 6, additional details regarding the operation of the productivity application 104 will be described. FIG. 4 is a flow diagram illustrating an example method for inserting a video into a document, in accordance with some embodiments presented herein. FIG. 5 is a flow diagram illustrating an example method for playing a video in a document, in accordance with some embodiments presented herein. FIG. 6 is a flow diagram illustrating an example method for printing or converting a document, in accordance with some embodiments presented herein.

It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts, and modules may be implemented in software, in firmware, in special purpose digital logic, and any combination thereof. It should be appreciated that more or fewer operations may be performed than shown in the figures and described herein. These operations may also be performed in a different order than those described herein.

In FIG. 4, a routine 400 begins at operation 402, where the productivity application 104 may receive one or more keywords from a user, such as the creating user 106 or the viewing user 108. For example, the productivity application 104 may provide a search interface through the search module 112. The user may submit one or more keywords via the search interface. After operation 402, the routine 400 may proceed to operation 404. It should be appreciated that productivity application 104 may receive other types of information from the user, including a URL (which may be translated into the playable graphical object) or the embed code for the playable graphical object itself, the present disclosure of which is not limited to any particular input.

At operation 404, the productivity application 104 may retrieve search results based on the keywords received from the user. For example, when the search module 112 receives the keywords via the search interface, the search module 112 may provide the keywords to a remote search service. The search service may retrieve search results based on the keywords and return the search results to the search module 112.

Each of the search results may correspond to a video object, such as the video object 120. Each video object may correspond to a particular web-based video that matches the keywords. For example, the video object 120 may correspond to the video 118. Each video object may include a default image, an embed code, and/or metadata regarding the corresponding web-based video. For example, the video object 120 may include the default image 122, the embed code 124A, and the metadata 126. After operation 404, the routine 400 may proceed to operation 406.

At operation 406, the productivity application 104 may provide the search results to the user. For example, the productivity application 104 may display the search results via a search results interface. In some embodiments, the search results interface may display the search results by displaying the default image from each of the video objects in the search results. In other embodiments, the search results may include text and/or images. Each of the search results may be selectable by the user. After operation 406, the routine 400 may proceed to operation 408.

At operation 408, the productivity application 104 may receive a user selection of one of the search results. In particular, a user may desire to insert a particular web-based video into the document 102. In order to insert the web-based video into the document 102, the user may select a corresponding one of the search results. For example, a search result may be selectable via a particular sequence of one or more mouse clicks or one or more taps via a touchscreen interface.

In an illustrative sequence, the user may click on one of the search results, which causes the productivity application 104 to display a preview window of the corresponding web-based video. The user can view the web-based video through the previous window. If the user is satisfied with the web-based video after previewing it, the user can select an interface element (e.g., an insert button) in order to insert the web-based video into the document 102. If the user is not satisfied with the web-based video after previewing it, the user can select another one of the search results. After operation 408, the routine 400 may proceed to operation 410.

At operation 410, the productivity application 104 may generate a playable graphical object, such as the playable graphical object 132, based on the default image contained in the video object. If a default image is not included in the video object, then a generic image may be used. In some embodiments, the productivity application 104 may generate the playable graphical object 132 by superimposing a play button or other indicator on the default image. The productivity application 104 may also associate the embed code with the playable graphical object 132. After operation 410, the routine 400 may proceed to operation 412.

At operation 412, the productivity application 104 may insert the playable graphical object 132 into the document 102. For example, the productivity application 104 may insert the playable graphical object 132 at the current location of the cursor or some other random or determined location. The productivity application 104 may provide functions (e.g., a drag interface) enabling the user to move the playable graphical object 132 after it has been inserted. The productivity application 104 may also provide functions enabling the user to customize the playable graphical object 132. For example, such functions may enable the user to resize, crop, and/or apply visual effects to the playable graphical object 132. After operation 412, the routine 400 may either repeat (e.g., periodically, continuously, or on demand as needed) or terminate.

In FIG. 5, a routine 500 begins at operation 502, where the productivity application 104 may display a document, such as the document 102, in a document viewing mode of the productivity application 104. In the document viewing mode, the productivity application 104 may permit a user to perform standard functions, such as viewing, editing, and/or scrolling, with respect to the document. The document 102 may include text as well as one or more playable graphical objects, such as the playable graphical object 132. Each of the playable graphical objects may correspond to a web-based video. For example, the playable graphical object 132 may correspond to the video 118. After operation 502, the routine 500 may proceed to operation 504.

At operation 504, the productivity application 104 may receive a user request to play the video 118 associated with the playable graphical object 132. The user may desire to view the video 118. Accordingly, the user may select the playable graphical object 132, which corresponds to the video 118. After operation 504, the routine 500 may proceed to operation 506.

At operation 506, the productivity application 104 may, in response to receiving the user request to play the video 118, transform from the document viewing mode 134 to the video viewing mode 136. In the video viewing mode 136, the productivity application 104 may place the video viewing window 138 on top of the document interface 110. The embed code 124A may be loaded in the video viewing window 138. In particular, the embed code 124A may access the viewing interface 130. In the video viewing mode 136, at least some of the standard functions available in the document viewing mode 134 may be restricted. Through the viewing interface 130, the user can control playback of the video 118. After operation 506, the routine 500 may proceed to operation 508.

At operation 508, the productivity application 104 may receive a user request to exit the video viewing mode 136. The user may request to exit the video viewing mode 136 when the user has finished viewing the video 118. The user may request to exit the video viewing mode 136 by selecting any portion of the document interface 110 outside of the video viewing window 138. After operation 508, the routine 500 may proceed to operation 510.

At operation 510, the productivity application 104 may, in response to receiving the user request to exit the video viewing mode 136, may transform from the video viewing mode 136 back to the document viewing mode 134. In the document viewing mode 134, the standard functions that were restricted in the video viewing mode 136 are made available again. After operation 510, the routine 500 may either repeat (e.g., periodically, continuously, or on demand as needed) or terminate.

In FIG. 6, a routine 600 may begin at operation 602, where the productivity application 104 may receive a user request to print the document 102 or convert the document 102 to another file format that does not support the video viewing mode 136. After operation 602, the routine 600 may proceed to operation 604.

At operation 604, the productivity application 104 may, in response to receiving the user request to print the document 102 or convert the document 102 to another file format, replace the playable graphical object 132 with the non-playable graphical object 142. After operation 604, the routine 600 may proceed to operation 606.

At operation 606, the productivity application 104 may print the document 102 or perform the document conversion. After operation 606, the routine 600 may either repeat (e.g., periodically, continuously, or on demand as needed) or terminate.

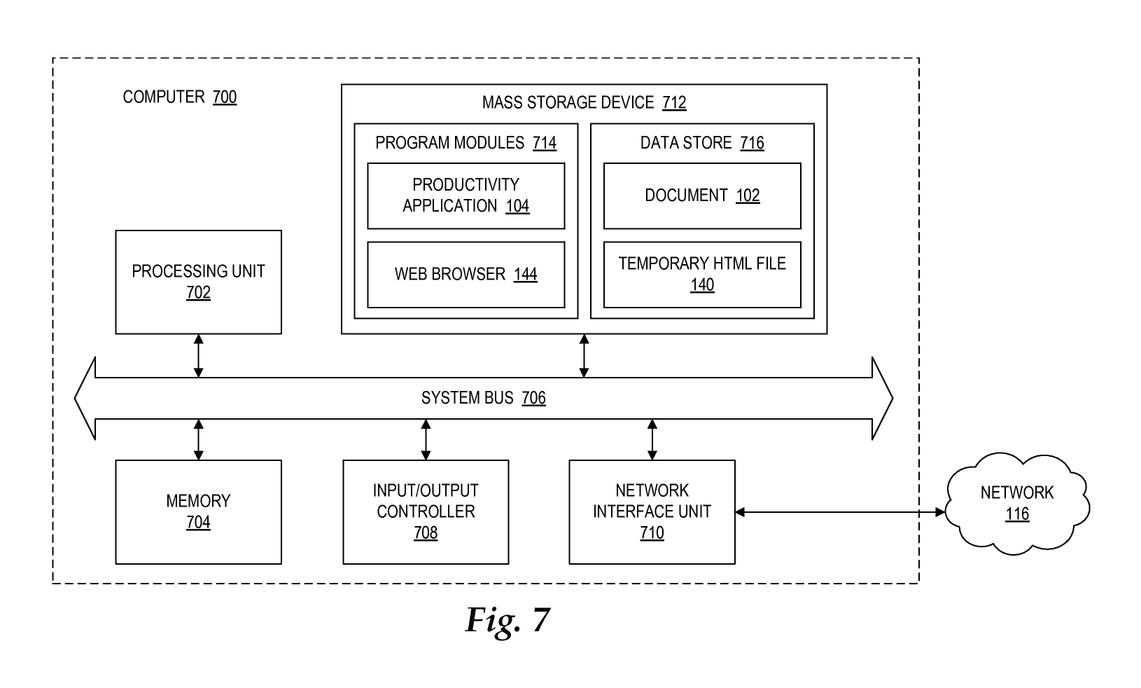

FIG. 7 is an example computer architecture diagram illustrating a computer 700. Examples of the computer 700 may include computing system 100. The computer 700 may include a central processing unit 702, a system memory 704, and a system bus 706 that couples the memory 704 to the central processing unit 702. The computer 700 may further include a mass storage device 712 for storing one or more program modules 714 and a data store 716. Examples of the program modules 714 may include the productivity application 104 and the web browser 144. The data store 716 may store the document 102 and the temporary HTML file 140. In some embodiments, productivity application 104 may be configured to perform one or more of methods described with respect to FIGS. 5, 6, and 7. The mass storage device 712 may be connected to the processing unit 702 through a mass storage controller (not shown) connected to the bus 706. The mass storage device 712 and its associated computer-storage media may provide non-volatile storage for the computer 700. Although the description of computer-storage media contained herein refers to a mass storage device, such as a hard disk or CD-ROM drive, it should be appreciated by those skilled in the art that computer-storage media can be any available computer storage media that can be accessed by the computer 700.

By way of example, and not limitation, computer-storage media may include volatile and non-volatile, removable and non-removable media implemented in any method or technology for the non-transitory storage of information such as computer-storage instructions, data structures, program modules, or other data. For example, computer-storage media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 700.

According to various embodiments, the computer 700 may operate in a networked environment using logical connections to remote computers through a network, such as the network 116. The computer 700 may connect to the network 116 through a network interface unit 710 connected to the bus 706. It should be appreciated that the network interface unit 710 may also be utilized to connect to other types of networks and remote computer systems. The computer 700 may also include an input/output controller 708 for receiving and processing input from a number of input devices (not shown), including a keyboard, a mouse, a microphone, and a game controller. The input/output controller 708 may also be configured to receive user input via gestures, tap/touch (e.g., via a touchscreen), and/or voice. Similarly, the input/output controller 708 may provide output to a display or other type of output device (not shown).

The bus 706 may enable the processing unit 702 to read code and/or data to/from the mass storage device 712 or other computer-storage media. The computer-storage media may represent apparatus in the form of storage elements that are implemented using any suitable technology, including but not limited to semiconductors, magnetic materials, optics, or the like. The computer-storage media may represent memory components, whether characterized as RAM, ROM, flash, or other types of technology. The computer-storage media may also represent secondary storage, whether implemented as hard drives or otherwise. Hard drive implementations may be characterized as solid state, or may include rotating media storing magnetically-encoded information.

The program modules 714 may include software instructions that, when loaded into the processing unit 702 and executed, cause the computer 700 to generate field sets. The program modules 714 may also provide various tools or techniques by which the computer 700 may participate within the overall systems or operating environments using the components, flows, and data structures discussed throughout this description. For example, the program modules 714 may implement interfaces for generating field sets.

In general, the program modules 714 may, when loaded into the processing unit 702 and executed, transform the processing unit 702 and the overall computer 700 from a general-purpose computing system into a special-purpose computing system customized to generate field sets. The processing unit 702 may be constructed from any number of transistors or other discrete circuit elements, which may individually or collectively assume any number of states. More specifically, the processing unit 702 may operate as a finite-state machine, in response to executable instructions contained within the program modules 714. These computer-executable instructions may transform the processing unit 702 by specifying how the processing unit 702 transitions between states, thereby transforming the transistors or other discrete hardware elements constituting the processing unit 702.

Encoding the program modules 714 may also transform the physical structure of the computer-storage media. The specific transformation of physical structure may depend on various factors, in different implementations of this description. Examples of such factors may include, but are not limited to: the technology used to implement the computer-storage media, whether the computer-storage media are characterized as primary or secondary storage, and the like. For example, if the computer-storage media are implemented as semiconductor-based memory, the program modules 714 may transform the physical state of the semiconductor memory, when the software is encoded therein. For example, the program modules 714 may transform the state of transistors, capacitors, or other discrete circuit elements constituting the semiconductor memory.

As another example, the computer-storage media may be implemented using magnetic or optical technology. In such implementations, the program modules 714 may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope of the present description, with the foregoing examples provided only to facilitate this discussion.

Based on the foregoing, it should be appreciated that concepts and technologies for the insertion and playback of video in documents are presented herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A method for generating a document, the method comprising:
retrieving a video object corresponding to a web-based video, the video object comprising a default image and video code;
generating, by a computer, a playable graphical object by superimposing an indicator on the default image;
associating the video code with the playable graphical object; and
inserting, via a productivity application, the playable graphical object into the document.

2. The method of claim 1, wherein retrieving the video object corresponding to the web-based video comprises:
receiving a user-submitted keyword;
retrieving search results corresponding to the user-submitted keyword, the search results comprising a plurality of video objects corresponding to a plurality of web-based videos, each of the plurality of web-based videos corresponding to one of the plurality of video objects, the plurality of web-based videos comprising the web-based video, the plurality of video objects comprising the video object;
providing the search results; and
receiving a user selection of the web-based video from the search results.

3. The method of claim 1, wherein the video code comprises an embed code, a URL, or video representing the web-based video.

4. The method of claim 1, wherein inserting, via the productivity application, the playable graphical object into the document comprises:
providing functionality enabling a user to customize the playable graphical object.

5. The method of claim 1, wherein the indicator comprises a play button.

6. The method of claim 1, the method further comprising:
displaying, via the productivity application, the document in a document viewing mode of the productivity application;
receiving a user selection of the playable graphical object in the document; and
responsive to receiving the user selection of the playable graphical object, transforming the productivity application from the document viewing mode to a video viewing mode configured to play the web-based video.

7. The method of claim 6, wherein the video code is embed code and wherein transforming the productivity application from the document viewing mode to a video viewing mode configured to play the web-based video comprises:
displaying, via the productivity application, a window on top of the document; and
loading the embed code in the window, the embed code enabling a user to play the web-based video inline within the window.

8. The method of claim 7, wherein loading the embed code in the window comprises:
generating a temporary HyperText Markup Language (HTML) file comprising logic configured to handle an event encountered when playing the web-based video;
inserting the embed code into the temporary HTML file; and
loading the temporary HTML file in the window.

9. The method of claim 8, the method further comprising:
receiving a second user selection of the document outside of the window; and
responsive to receiving the second user selection, transforming the productivity application from the video viewing mode to the document viewing mode and erasing the temporary HTML file.

10. The method of claim 1, the method further comprising:
receiving a user request to print the document;
responsive to receiving the user request to print the document, generating a non-playable graphical object that does not include the indicator;
replacing the playable graphical object with the non-playable graphical object in the document; and
upon replacing the playable graphical object with the non-playable graphical object in the document, printing the document.

11. A computer-readable storage medium having computer-executable instructions stored thereon which, when executed by a computer, cause the computer to:
receive a user-submitted keyword;
retrieve search results corresponding to the user-submitted keyword, the search results comprising a plurality of video objects corresponding to a plurality of web-based videos, each of the plurality of video objects comprising a default image, an embed code, and metadata;
display the search results;
receive a user selection of one of the search results, the one of the search results comprising a first video object from the plurality of video objects, the first video object corresponding to a first web-based video in the plurality of web-based videos, the first video object comprising a first default image, a first embed code, and first metadata;
generate a playable graphical object by superimposing an indicator on the first default image;
associate the first embed code with the playable graphical object; and
insert, via a productivity application, the playable graphical object into a document.

12. The computer-readable storage medium of claim 11, wherein to insert, via the productivity application, the playable graphical object into the document, the computer-executable instructions, when executed by the computer, cause the computer to:
provide functionality enabling a user to resize the playable graphical object, to crop the playable graphical object, and to apply visual effects to the playable graphical object.

13. The computer-readable storage medium of claim 11, wherein the computer-executable instructions, when executed by the computer, further cause the computer to:
display, via the productivity application, the document in a document viewing mode of the productivity application;
receive a second user selection of the playable graphical object in the document; and
responsive to receiving the second user selection of the playable graphical object, transform the productivity application from the document viewing mode to a video viewing mode configured to play the web-based video, wherein user functions for editing the document are restricted while the productivity application is in the video viewing mode.

14. The computer-readable storage medium of claim 13, wherein to transform the productivity application from the document viewing mode to the video viewing mode configured to play the first web-based video, the computer-executable instructions, when executed by the computer, cause the computer to display, via the productivity application, a window on top of the document; open an external browser window; or play the first web-based video within the document.

15. The computer-readable storage medium of claim 14, wherein to load the embed code in the window, the computer-executable instructions, when executed by the computer, cause the computer to:
generate a temporary HyperText Markup Language (HTML) file comprising logic configured to handle an event encountered when playing the first web-based video;
insert the first embed code into the temporary HTML file; and
load the temporary HTML file in the window.

16. The computer-readable storage medium of claim 15, wherein the computer-executable instructions, when executed by the computer, further cause the computer to:
receive a third user selection of the document outside of the window; and
responsive to receiving the third user selection, transform the productivity application from the video viewing mode to the document viewing mode and erasing the temporary HTML file.

17. The computer-readable storage medium of claim 13, wherein the first metadata comprises a uniform resource locator (URL) to a web page configured to play the first web-based video; and wherein the computer-executable instructions, when executed by the computer, further cause the computer to:
receive a user request to convert the document to a format that does not support the video viewing mode;
responsive to receiving the user request to convert the document to the format that does not support the video viewing mode, generate a non-playable graphical object that does not contain the indicator;
associate the non-playable graphical object with a hyperlink to the URL;
replace the playable graphical object with the non-playable graphical object in the document; and
upon replacing the playable graphical object with the non-playable graphical object in the document, convert the document to the format.

18. A computer system, comprising:
a processor;
a memory communicatively coupled to the processor; and
a program module which executes in the processor from the memory and which, when executed by the processor, causes the processor to:
receive a user-submitted keyword,
retrieve search results corresponding to the user-submitted keyword, the search results comprising a plurality of video objects corresponding to a plurality of web-based videos, each of the plurality of video objects comprising a default image, an embed code, and metadata,
display the search results,
receive a user selection of one of the search results, the one of the search results comprising a first video object from the plurality of video objects, the first video object corresponding to a first web-based video in the plurality of web-based videos, the first video object comprising a first default image, a first embed code, and first metadata,
generate a playable graphical object by superimposing a play button on the first default image,
associate the first embed code with the playable graphical object,
insert, via a word processing application, the playable graphical object into a word processing document,
display, via the word processing application, the word processing document in a document viewing mode of the word processing application,
receive a second user selection of the playable graphical object in the word processing document, and
responsive to receiving the second user selection of the playable graphical object, transform the word processing application from the document viewing mode to a video viewing mode configured to play the first web-based video.

19. The computer system of claim 18, wherein to transform the word processing application from the document viewing mode to the video viewing mode configured to play the first web-based video, the program module, when executed by the processor, causes the processor to:
display, via the word processing application, a window on top of the word processing document; and
load the first embed code in the window, the first embed code enabling a user to play the first web-based video inline within the window.

20. The computer system of claim 19, wherein to load the first embed code in the window, the program module, when executed by the processor, causes the computer to:
generate a temporary HyperText Markup Language (HTML) file comprising logic configured to handle an event encountered when playing the first web-based video;
insert the embed code into the temporary HTML file; and
load the temporary HTML file in the window.
